(19) United States
(12) Patent Application Publication
(10) Pub. No.: US 2025/0135846 A1
(43) Pub. Date: May 1, 2025

(54) CASE, COMPRESSOR AND VEHICLE

(71) Applicant: BYD COMPANY LIMITED, SHENZHEN (CN)

(72) Inventors: Huan LI, Shenzhen (CN); Li AI, Shenzhen (CN); Lijuan TIAN, Shenzhen (CN); Guofeng LUO, Shenzhen (CN)

(21) Appl. No.: 19/006,594

(22) Filed: Dec. 31, 2024

Related U.S. Application Data
(63) Continuation of application No. PCT/CN2023/104945, filed on Jun. 30, 2023.

(30) Foreign Application Priority Data
Jul. 5, 2022 (CN) 202221735042.6

(51) Int. Cl. B60H 1/32

(52) U.S. Cl. CPC B60H 1/3229

(57) ABSTRACT

A case is applicable to a compressor. The compressor includes a compressor controller and a compressor body. The compressor controller is disposed on the compressor body, and the case at least partially covers the compressor controller.

### CROSS-REFERENCE TO RELATED APPLICATIONS

This application is a continuation application of International Patent Application No. PCT/CN2023/104945, filed on Jun. 30, 2023, which is based on and claims priority to and benefits of Chinese Patent Application No. 202221735042.6, filed on Jul. 5, 2022. The entire content of all of the above-referenced applications is incorporated herein by reference.

### FIELD

The present disclosure relates to the technical field of compressors, and in particular to a case, a compressor, and a vehicle.

### BACKGROUND

In recent years, desire for the comfort and reduction of vibration noise of vehicles are increased with the popularization of new energy vehicles. Compared with traditional fuel vehicles, new energy vehicles have no engine noise, which has higher requirements on NVH (Noise, vibration, and harshness) performance. Among the many components producing noise in a vehicle, the vehicle air conditioning system is one of the components causing significant noise. The compressor is the main excitation source of automotive air conditioning NVH, so how to effectively reduce the compressor NVH is one of the key factors. The uncomfortable noise outside the vehicle generated by the compressor during operations is mainly concentrated in the mid-high frequency range (above 1000 Hz), and the acoustic package has a very good noise reduction effect on the noise in this frequency range, so the reduction of noise can be greatly improved by the acoustic package design.

The existing acoustic package design for automotive air conditioning compressors, single-layered or multi-layered, is divided into upper and lower or left and right sections combined at a planar structure. This structure cannot be completely contact with each other during the actual installation process, resulting in gaps and limited noise reduction effects.

### SUMMARY

The present disclosure solves at least one of the technical problems existing in the prior art. Therefore, the present disclosure is to propose a case that can effectively absorb or isolate the noise generated by the compressor.

The present disclosure proposes a compressor including the above-mentioned case.

The present disclosure also proposes a vehicle including the above-mentioned compressor.

The case according to the present disclosure is applicable to a compressor, where the compressor includes a compressor controller and a compressor body, the compressor controller is disposed on the compressor body, and the case at least partially covers the compressor controller.

The case according to the present disclosure, at least partially covers the compressor controller, thereby the noise generated by the compressor is effectively absorbed or isolated, and the noise reduction capability is greatly improved.

In one example of the present disclosure, the case is integrally molded.

In one example of the present disclosure, the case includes: a first covering portion and a second covering portion, where the first covering portion and the second covering portion define a cavity, and the compressor controller is at least partially disposed in the cavity.

In one example of the present disclosure, a volume defined by the first covering portion and a volume defined by the second covering portion are different.

In one example of the present disclosure, an opening of the first covering portion and an opening of the second covering portion are face to each other, and the first covering portion and the second covering portion abut against each other.

In one example of the present disclosure, the first covering portion includes a first mating end face, the second covering portion includes a second mating end face, the first mating end face includes a first protrusion portion, and the second mating end face includes a first recessed portion coupling with the first protrusion portion.

In one example of the present disclosure, the first covering portion includes a first mating end face having a plurality of first protrusion portions spaced apart in a thickness direction of the case, and the second covering portion includes a second mating end face having a plurality of first recessed portions spaced apart in the thickness direction of the case. The first protrusion portions are coupled to the first recessed portions, respectively.

In one example of the present disclosure, the cross-section of the first protrusion portion is configured as a rectangle, a triangle or a semicircle.

In one example of the present disclosure, the height of the first protrusion portion protruding from the first mating end face is h, and h≥4 mm.

In one example of the present disclosure, the case includes a first covering layer and a second covering layer, the first covering layer covers the compressor controller, and the second covering layer covers the first covering layer.

In one example of the present disclosure, a hardness of the second covering layer is greater than a hardness of the first covering layer, and a thickness of the second covering layer is less than a thickness of the first covering layer.

In one example of the present disclosure, the first covering layer includes a third covering portion and a fourth covering portion, the third covering portion includes a third mating end face, the fourth covering portion includes a fourth mating end face, and the third mating end face and the fourth mating end face are coupled with each other.

In one example of the present disclosure, the second covering layer includes a fifth covering portion and a sixth covering portion, the fifth covering portion includes a fifth mating end face, the sixth covering portion includes a sixth mating end face, and the fifth mating end face and the sixth mating end face are coupled with each other.

In one example of the present disclosure, a mating surface where the third covering portion couples with the fourth covering portion does not coincide with a mating surface where the fifth covering portion couples with the sixth covering portion.

In one example of the present disclosure, an angle between the third mating end face and the fifth mating end face or between the fourth mating end face and the sixth mating end face is α, and 0°<α>90°.

In one example of the present disclosure, the third mating end face and the fourth mating end face are coupled at a first mating surface, the fifth mating end face and the sixth mating end face are coupled at a second mating surface, a distance between the first mating surface and the second mating surface is d0, and d0≥4 mm.

In one example of the present disclosure, two first mating segments are parallel to each other between the third mating end face and the fourth mating end face, and two second mating segments are parallel to each other between the fifth mating end face and the sixth mating end face. The two first mating segments are disposed on an outer peripheral wall of the first covering layer, the two second mating segments are disposed on an outer peripheral wall of the second covering layer, each of the first mating segments is in parallel with a corresponding one of the second mating segments, a distance between a first mating segment adjacent to the third mating end face and a second mating segment adjacent to the fifth mating end face or a distance between a first mating segment adjacent to the fourth mating end face and a second mating segment adjacent to the sixth mating end face is d1, and d1≥4 mm.

In one example of the present disclosure, a flange portion is disposed on the fifth covering portion and/or the sixth covering portion, and covers an outer edge of the fifth mating end face and/or an outer edge of the sixth mating end face, where a width of the flange portion is d2, and d2≥4 mm.

In one example of the present disclosure, a plurality of first covering layers are stacked on each other in the thickness direction of the case; or/and a plurality of second covering layers are stacked on each other in the thickness direction.

In one example of the present disclosure, an intermediate layer is disposed between the first covering layer and the second covering layer.

A compressor, including the above-mentioned case.

A vehicle, including the above-mentioned compressor.

Additional aspects and advantages of the present disclosure will be presented in the following description, some of which will be obvious from the following description or understood by practice of the present disclosure.

### BRIEF DESCRIPTION OF THE DRAWINGS

The above and/or additional aspects and advantages of the present disclosure will be obvious and easily understood from the description of the examples in conjunction with the following drawings:

FIG. 1 is a schematic diagram of a case according to a first example of the present disclosure in one direction;

FIG. 2 is a partial enlarged schematic diagram of circle A in FIG. 1;

FIG. 3 is a schematic diagram of a case according to a second example of the present disclosure in one direction;

FIG. 4 is a partial enlarged schematic diagram of circle B in FIG. 3;

FIG. 5 is a cross-sectional view of a first covering layer and a second covering layer according to a third example of the present disclosure;

FIG. 6 is an exploded view of a case according to a third example of the present disclosure;

FIG. 7 is a compressor according to an example of the present disclosure; and

FIG. 8 is a vehicle according to an example of the present disclosure.

### DETAILED DESCRIPTION

Examples of the present disclosure are described below in detail, illustrations of which are shown in the accompanying drawings, where the same or similar reference numerals from beginning to the end represent the same or similar elements or elements having the same or similar functions. The examples described below with reference to the accompanying drawings are examples and are to explain the present disclosure, but should not be construed as a limitation on the present disclosure.

The case 100 according to the example of the present disclosure can be applicable to a compressor 1000, where the compressor 1000 includes a compressor controller 200 and a compressor body 300. The compressor controller 200 is the primary source of noise, so the entire compressor 1000 or at least the compressor controller 200 can be covered by the case 100.

In an example, the compressor controller 200 is arranged/disposed on the compressor body 300, and the case 100 at least partially covers the compressor controller 200. That is to say, the case 100 can cover the entire compressor controller 200, or of course can cover a portion of the compressor controller 200, as long as the case 100 covers the compressor controller 200 to reduce the noise generated by the compressor controller 200.

The case 100 according to the example of the present disclosure can at least partially cover the compressor controller 200, thereby the noise generated by the compressor 1000 is effectively absorbed or isolated and the noise reduction capability is greatly improved.

### First Example

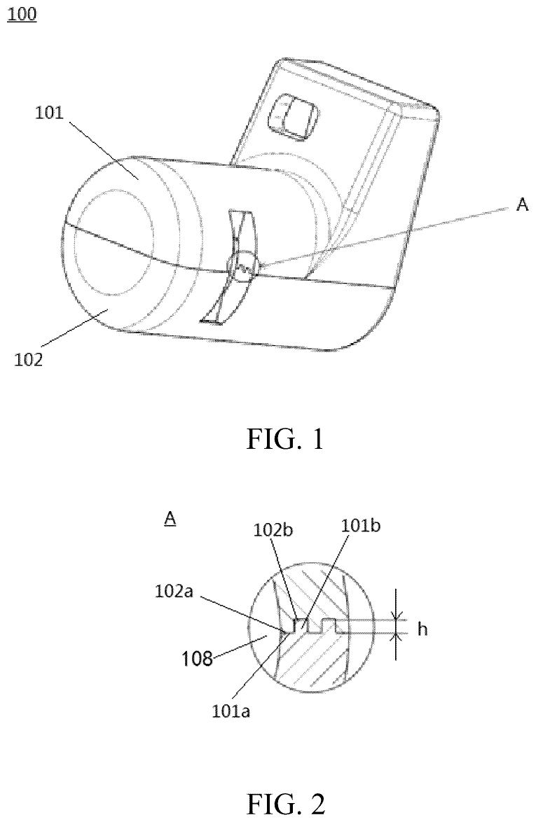

In this example, as shown in FIGS. 1 and 2, the case 100 includes a first covering portion 101 and a second covering portion 102, where the first covering portion 101 and the second covering portion 102 define a housing cavity 108, and the compressor controller 200 is at least partially disposed in the housing cavity 108. The first covering portion 101 and the second covering portion 102 are of a split structure. Since the case 100 is constructed as a structure similar to a rotating body, the case 100 is divided into the first covering portion 101 and the second covering portion 102 for processing and assembling, which can greatly improve the installation efficiency of the case 100 installing on the compressor controller 200.

A volume of the first covering portion 101 and a volume of the second covering portion 102 can be the same. The first covering portion 101 is one half of the case 100, and the second covering portion 102 is the other half of the case 100. Therefore, the processing of the first covering portion 101 and the second covering portion 102 is easier. If the case 100 is a symmetrical rotating body, only one mold is required to process the first covering portion 101 and the second covering portion 102 at the same time.

It should be noted that the case 100 can also be an integral molded structure, so the structure of the case 100 is simplified, which makes producing and processing easier, thereby the production efficiency of the case 100 is greatly improved. In addition, the strength of the case 100 is also improved to a certain extent.

It should be noted that the volume defined by the first covering portion 101 and the volume defined by the second covering portion 102 can also be different, and the first covering portion 101 and the second covering portion 102 with different volumes can meet a variety of different manufacturing processes. Therefore, the first covering portion 101 and the second covering portion 102 with different volumes can be manufactured according to the requirements.

Furthermore, the opening of the first covering portion 101 and the opening of the second covering portion 102 are opposite to each other (e.g., such as facing to reach other), and the opening side of the first covering portion 101 and the opening side of the second covering portion 102 cooperate with each other, that is, the first covering portion 101 and the second covering portion 102 abut against each other, so that the first covering portion 101 and the second covering portion 102 jointly define a cavity, such as the housing cavity 108.

In this example, as shown in FIG. 2, a first mating end face 101a and a second mating end face 102a mating/coupling with each other are respectively arranged on the first covering portion 101 and the second covering portion 102. A first protrusion portion 101b is arranged on the first mating end face 101a, and a first recessed portion 102b mating with the first protrusion portion 101b is arranged on the second mating end face 102a. As a result, the contact area between the first mating end face 101a and the second mating end face 102a is greatly improved, and the noise generated by the compressor controller 200 leaking from a gap between the first mating end face 101a and the second mating end face 102a is reduced.

The first protrusion portions 101b and the first recessed portions 102b can both be multiples, each of the multiple first protrusion portions 101b is mated with the corresponding first recessed portion 102b, and multiple first protrusion portions 101b are spaced apart from each other. Thus, when multiple first protrusion portions 101b and multiple first recessed portions 102b are mated, portions of the first mating end face 101a and portions of the second mating end face 102a are staggered to form a maze-like structure, thereby the sealing performance between the first mating end face 101a and the second mating end face 102a is improved, and the noise generated by the compressor controller 200 leaking from the gap between the first mating end face 101a and the second mating end face 102a is greatly reduced.

It can be understood that multiple first protrusion portions 101b are spaced apart in the thickness direction of the case 100, and multiple first recessed portions 102b are spaced apart in the thickness direction of the case 100. The thickness direction of the case 100 is the inside-outside direction of the case 100. Mating between the multiple first protrusion portions 101b spaced apart in the thickness direction of the case 100 and multiple first recessed portions 102b spaced apart in the thickness direction of the case 100, can effectively reduce the amount of noise generated by the compressor controller 200 inside the case 100 to be transmitted to the outside of the case 100.

In an example, the cross-section of the first protrusion portions 101b is configured as a shape of a rectangle, a triangle or a semicircle. The sealing performance between the first mating end face 101a and the second mating end face 102a is directly or indirectly affected by the cross-sectional shape of the first protrusion portion 101b. The first protrusion portion 101b or the first recessed portion 102b with different cross-sectional shapes can be selected according to the requirements.

In this example, as shown in FIG. 2, the height of the first protrusion portion 101b protruding from the first mating end face 101a is h, which satisfies: h>4 mm. The noise reduction effect can be improved by at least 2 dB when h≥4 mm.

### Second Example

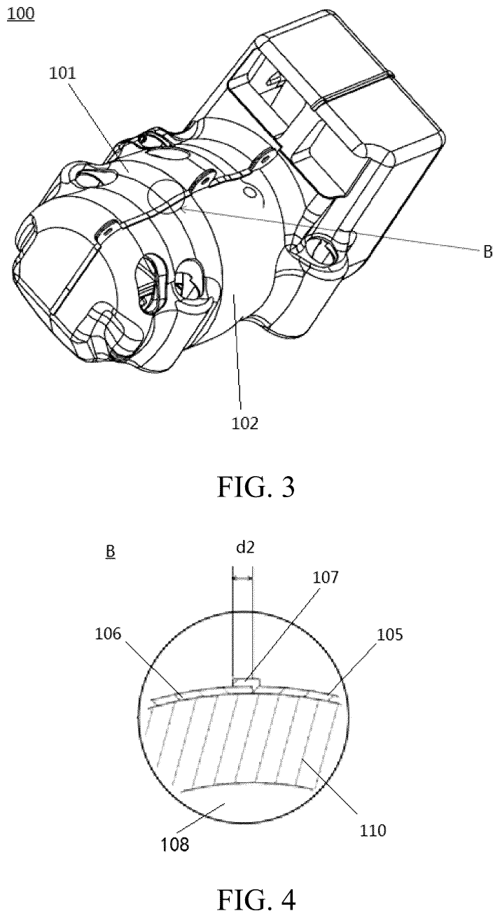

Referring to FIGS. 3 and 4, the case 100 includes a first covering portion 101 and a second covering portion 102, where the first covering portion 101 and the second covering portion 102 define a housing cavity 108, and the compressor controller 200 is at least partially disposed in the housing cavity 108. The first covering portion 101 and the second covering portion 102 are of a split structure. A volume of the first covering portion 101 and a volume of the second covering portion 102 are the same. The first covering portion 101 is one half of the case 100, and the second covering portion 102 is the other half of the case 100.

It should be noted that in this example the case 100 can also be an integral molded structure, and the volume of the first covering portion 101 and the volume of the second covering portion 102 can also be different. A thickness of the case 100 in this example is smaller than that of the case 100 in the first example, and a hardness of the case 100 in this example is greater than that of the case 100 in the first example.

It should be noted that the cases in the first example and the second example can cover on the outside of the compressor 1000, which can also reduce the noise of the compressor 1000.

### Third Example

As shown in FIG. 6, the case 100 includes a first covering layer 110 and a second covering layer 120, where the first covering layer 110 covers the compressor controller 200, and the second covering layer 120 covers the first covering layer 110. That is to say, the case 100 can be a double-layered structure, so the first covering layer 110 and the second covering layer 120 can jointly reduce the noise generated by the compressor controller 200. The first covering layer 110 has the same structure as the case 100 in the first example, and the second covering layer 120 has the same structure as the case 100 in the second example.

Furthermore, a hardness of the second covering layer 120 is greater than a hardness of the first covering layer 110, and a thickness of the second covering layer 120 is less than a thickness of the first covering layer 110. The first covering layer 110 can be a sound absorbing layer, and the second covering layer 120 can be a sound insulating layer. The first covering layer 110 can be made of a flexible material, such as a sound absorbing sponge, etc., and the second covering layer 120 can be constructed as a hard plastic layer. For double-layered or multi-layered covering layers, the outer layer structure can play an effective sound insulation role when the inner layer structure has an acoustic leak.

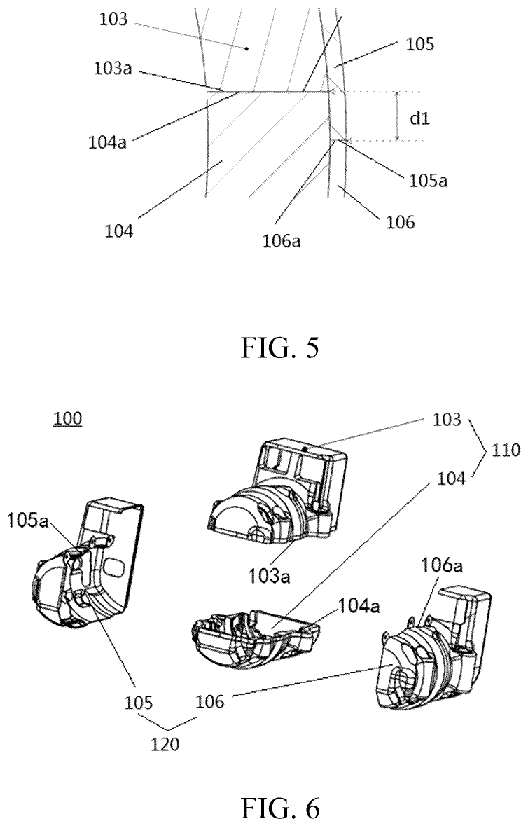

In this example, as shown in FIGS. 5 and 6, the first covering layer 110 includes a third covering portion 103 and a fourth covering portion 104, and a third mating end face 103a and a fourth mating end face 104a mating/coupling with each other are arranged on the third covering portion 103 and the fourth covering portion 104, respectively. That is to say, the structure of the inner layer in the case 100 is also formed by the abutment of two halves, and the third covering portion 103 and the fourth covering portion 104 are of a split structure. Since the first covering layer 110 is constructed as a structure similar to a rotating body, the first covering layer 110 is divided into the third covering portion 103 and the fourth covering portion 104 for processing and assembling, which can greatly improve the installation efficiency of the first covering layer 110 on the compressor controller 200. In an example, the third mating end face 103a is arranged on the third covering portion 103, and the fourth mating end face 104a is arranged on the fourth covering portion 104. When the third covering portion 103 and the fourth covering portion 104 are assembled, the third mating end face 103a and the fourth mating end face 104a are in contact with each other. In an example, a mating surfaces of the third mating end face 103a and the fourth mating end face 104a can be a flat surface or a mating concave-convex surface.

Furthermore, the second covering layer 120 includes a fifth covering portion 105 and a sixth covering portion 106, and a fifth mating end face 105a and a sixth mating end face 106a mating with each other are arranged on the fifth covering portion 105 and the sixth covering portion 106, respectively. That is to say, the structure of the inner layer in the case 100 is also formed by the abutment of two halves, and the fifth covering portion 105 and the sixth covering portion 106 are of a split structure. Since the second covering layer 120 is constructed as a structure similar to a rotating body, the second covering layer 120 is divided into the fifth covering portion 105 and the sixth covering portion 106 for processing and assembling, which can greatly improve the installation efficiency of the second covering layer 120 on the first covering layer 110. In an example, the fifth mating end face 105a is arranged on the fifth covering portion 105, and the sixth mating end face 106a is arranged on the sixth covering portion 106. When the fifth covering portion 105 and the sixth covering portion 106 are assembled, the fifth mating end face 105a or the sixth mating end face 106a are in contact with each other. In an example, a mating surface of the fifth mating end face 105a or the sixth mating end face 106a can be a flat surface or a mating concave-convex surface.

In this example, as shown in FIGS. 5 and 6, the mating surface of the third covering portion 103 and the fourth covering portion 104 does not coincide with the mating surface of the fifth covering portion 105 and the sixth covering portion 106. That is to say, the mating surface between the third covering portion 103 and the fourth covering portion 104 and the mating surface between the fifth covering portion 105 and the sixth covering portion 106 are staggered with each other. As shown in FIG. 6, the mating surface between the third covering portion 103 and the fourth covering portion 104 is arranged horizontally, and the mating surface between the fifth covering portion 105 and the sixth covering portion 106 is arranged vertically. Therefore, even if the sound inside the first covering layer 110 leaks out from between the third covering portion 103 and the fourth covering portion 104 (e.g., a gap between the third and fourth covering parts), it will not directly enter between the fifth covering portion 105 and the sixth covering portion 106, and the sound can be further absorbed between the first covering layer 110 and the second covering layer 120.

In some examples of the present disclosure, an angle between the third mating end face 103a and the fifth mating end face 105a or between the fourth mating end face 104a and the sixth mating end face 106a is α (not shown in the figures), which satisfies: 0°<α≤90°. That is to say, the mating gap between the third covering portion 103 and the fourth covering portion 104 is not aligned to the mating gap between the fifth covering portion 105 and the sixth covering portion 106, and the two gaps are staggered in the circumferential direction, thereby the directly transmitting of the noise of the compressor controller 200 through the gaps is effectively avoided. The noise reduction effect of this solution can be improved by more than 1 dB.

For example, as shown in FIG. 6, the third covering portion 103 and the fourth covering portion 104 can be opposite to each other in the up and down directions, and the third mating end face 103a and the fourth mating end face 104a extend in the horizontal direction. The fifth covering portion 105 and the sixth covering portion 106 can be opposite to each other in the horizontal direction (e.g., a left-right direction), and the fifth mating end face 105a and the sixth mating end face 106a extend in the vertical direction.

In some examples of the present disclosure, the third mating end face 103a and the fourth mating end face 104a have a first mating surface, the fifth mating end face 105a and the sixth mating end face 106a have a second mating surface, and a distance between the first mating surface and the second mating surface is d0, which satisfies: d0≥4 mm. It should be noted that the first mating surface refers to a contact mating surface between the third mating end face 103a and the fourth mating end face 104a, the second mating surface refers to a contact mating surface between the fifth mating end face 105a and the sixth mating end face 106a, and the distance between the first mating surface and the second mating surface refers to a distance between any point on the first mating surface and any point on the second mating surface. The noise reduction effect can be improved by more than 2 dB when d0≥4 mm.

In this example, as shown in FIG. 5, two first mating segments parallel to each other are arranged between the third mating end face 103a and the fourth mating end face 104a, and two second mating segments parallel to each other are arranged between the fifth mating end face 105a and the sixth mating end face 106a. Both of the first mating segments and both of the second mating segments are respectively located on an outer peripheral wall of the first covering layer 110 and an outer peripheral wall of the second covering layer 120, and the first mating segments and the second mating segments are parallel to each other. A distance between the first mating segment and the second mating segment on the same side is d1, which satisfies: d1≥4 mm. The noise reduction effect can be improved by more than 2 dB when d1≥4 mm.

In some examples of the present disclosure, as shown in FIG. 4, a flange portion 107 covering outer edges of the fifth mating end face 105a and/or the sixth mating end face 106a is arranged on the fifth covering portion 105 and/or the sixth covering portion 106, and the width of the flange portion 107 is d2, which satisfies: d2>4 mm. Therefore, the sealing gap between the fifth covering portion 105 and the sixth covering portion 106 can be stopped by the flange portion 107, further improving the noise reduction effect of the case 100.

According to some examples of the present disclosure, an intermediate layer is arranged between the first covering layer 110 and the second covering layer 120. That is to say, the first covering layer 110, the intermediate layer and the second covering layer 120 are constructed like a sandwich structure, and the intermediate layer is sandwiched between the first covering layer 110 and the second covering layer 120. The material of the intermediate layer can be the same as that of the first covering layer 110, and of course can also be the same as that of the second covering layer 120. The intermediate layer can be constructed as a sound-absorbing layer to further absorb the sound that is not absorbed by the first covering layer 110. The intermediate layer can also be constructed as a sound-insulating layer. If the first covering layer 110 fails to completely absorb and insulate the sound, the leaked sound can be first insulated by the intermediate layer, and then only the sound leaked from the intermediate layer needs to be further insulated by the second covering layer 120. Therefore, even if the sound is not completely absorbed and dissipated by the first covering layer 110, the leaked sound can be insulated or the energy can be absorbed by the intermediate layer, therefore the sound-absorbing and sound-isolating effect of the case 100 is further increased.

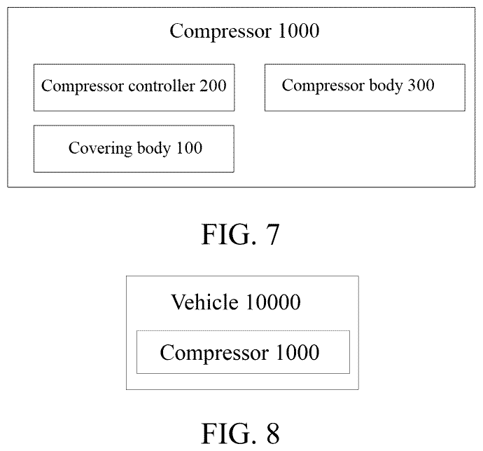

The compressor 1000 according to the example of the present disclosure is described briefly below with reference to FIG. 7.

The compressor 1000 according to the example of the present disclosure includes the above-mentioned case 100. Since the above-mentioned case 100 is arranged on the compressor 1000 according to the present disclosure, the amount of noise of the compressor 1000 can be greatly reduced, and the NVH performance of the vehicle 10000 is improved.

The vehicle 10000 according to the example of the present disclosure is described briefly below with reference to FIG. 8.

According to the example of the present disclosure, the vehicle 10000 includes the above-mentioned compressor 1000. Since the above-mentioned compressor 1000 is arranged on the vehicle 10000 according to the example of the present disclosure, the noise of the compressor 1000 is significantly controlled, the NVH performance of the whole vehicle is improved, and the overall quality of the vehicle 10000 is improved.

In the description of this specification, reference to terms such as “one embodiment”, “some embodiments”, “illustrative embodiment”, “example”, “specific example”, or “some examples” means that the features, structures, materials or characteristics described in conjunction with the embodiment or example are included in at least one embodiment or example of the present disclosure. In this specification, the expressions of the above terms do not necessarily refer to the same embodiment or example. Furthermore, the features, structures, materials, or characteristics described may be combined in any suitable manner in any one or more embodiments or examples.

Although examples of the present disclosure have been shown and described, a person skilled in the art will appreciate that various changes, modifications, substitutions and alterations may be made to the examples without departing from the principles and spirit of the present disclosure, the scope of which is defined by the claims and their equivalents.

### REFERENCE NUMERALS

Case 100, first covering portion 101, first mating end face 101a, first protrusion portion 101b, second covering portion 102, second mating end face 102a, first recessed portion 102b, housing cavity 108;
First covering layer 110, third covering portion 103, third mating end face 103a, fourth covering portion 104, fourth mating end face 104a;
Second covering layer 120, fifth covering portion 105, fifth mating end face 105a, sixth covering portion 106, sixth mating end face 106a, flange portion 107; and
Vehicle 10000; compressor 1000; compressor controller 200, compressor body 300.

What is claimed is:

1. A case, applicable to a compressor, wherein the compressor comprises a compressor body and a compressor controller disposed on the compressor body, wherein the case at least partially covers the compressor controller.

2. The case according to claim 1, wherein the case is integrally molded.

3. The case according to claim 1, further comprising a first covering portion and a second covering portion defining a cavity, wherein the compressor controller is at least partially disposed in the cavity.

4. The case according to claim 3, wherein an opening of the first covering portion and an opening of the second covering portion face each other, and the first covering portion and the second covering portion abut against each other.

5. The case according to claim 4, wherein the first covering portion comprises a first mating end face, the second covering portion comprises a second mating end face, the first mating end face comprises a first protrusion portion, and the second mating end face comprises a first recessed portion coupling with the first protrusion portion.

6. The case according to claim 4, wherein the first covering portion comprises a first mating end face having a plurality of first protrusion portions spaced apart in a thickness direction of the case, and the second covering portion comprises a second mating end face having a plurality of first recessed portions spaced apart in the thickness direction of the case, wherein the first protrusion portions are coupled to the first recessed portions, respectively.

7. The case according to claim 5, wherein a height of the first protrusion portion protruding from the first mating end face is h, and h≥4 mm.

8. The case according to claim 1, further comprising a first covering layer and a second covering layer, wherein the first covering layer covers the compressor controller, and the second covering layer covers the first covering layer.

9. The case according to claim 8, wherein a hardness of the second covering layer is greater than a hardness of the first covering layer, and a thickness of the second covering layer is less than a thickness of the first covering layer.

10. The case according to claim 8, wherein the first covering layer comprises a third covering portion and a fourth covering portion, the third covering portion comprises a third mating end face, the fourth covering portion comprises a fourth mating end face, and the third mating end face and the fourth mating end face are coupled with each other.

11. The case according to claim 10, wherein the second covering layer comprises a fifth covering portion and a sixth covering portion, the fifth covering portion comprises a fifth mating end face, the sixth covering portion comprises a sixth mating end face, and the fifth mating end face and the sixth mating end face are coupled with each other.

12. The case according to claim 11, wherein a mating surface where the third covering portion couples with the fourth covering portion does not coincide with a mating surface where the fifth covering portion couples with the sixth covering portion.

13. The case according to claim 11, wherein an angle between the third mating end face and the fifth mating end face or between the fourth mating end face and the sixth mating end face is α, and 0°<α>90°.

14. The case according to claim 11, wherein the third mating end face and the fourth mating end face are coupled at a first mating surface, the fifth mating end face and the sixth mating end face are coupled at a second mating surface, a distance between the first mating surface and the second mating surface is d0, and d0≥4 mm.

15. The case according to claim 11, further comprising: two first mating segments parallel to each other between the third mating end face and the fourth mating end face, and two second mating segments parallel to each other between the fifth mating end face and the sixth mating end face, wherein
the two first mating segments are disposed on an outer peripheral wall of the first covering layer, the two second mating segments are disposed on an outer peripheral wall of the second covering layer, each of the first mating segments is in parallel with a corresponding one of the second mating segments, a distance between a first mating segment adjacent to the third mating end face and a second mating segment adjacent to the fifth mating end face or a distance between a first mating segment adjacent to the fourth mating end face and a second mating segment adjacent to the sixth mating end face is d1, and d1≥4 mm.

16. The case according to claim 11, further comprising a flange portion disposed on the fifth covering portion and/or the sixth covering portion and covering an outer edge of the fifth mating end face and/or an outer edge of the sixth mating end face, wherein a width of the flange portion is d2, and d2≥4 mm.

17. The case according to claim 1, further comprising:
a plurality of first covering layers stacked on each other in a thickness direction of the case; or/and
a plurality of second covering layers stacked on each other in the thickness direction.

18. The case according to claim 8, further comprising an intermediate layer between the first covering layer and the second covering layer.

19. A compressor, comprising a case, wherein
the case is applicable to a compressor, the compressor comprises a compressor body and a compressor controller disposed on the compressor body, and the case at least partially covers the compressor controller.

20. A vehicle, comprising a compressor, wherein
the compressor comprises a compressor body and a compressor controller disposed on the compressor body, and the compressor controller is at least partially covered by a case.
